(19) United States
(12) Patent Application Publication
(10) Pub. No.: US 2026/0094331 A1
(43) Pub. Date: Apr. 2, 2026

(54) IMAGE PROCESSING APPARATUS, METHOD, AND PROGRAM

(71) Applicant: FUJIFILM Corporation, Tokyo (JP)

(72) Inventors: Keisuke YAMAKAWA, Tokyo (JP); Wataru FUKUDA, Tokyo (JP)

(73) Assignee: FUJIFILM Corporation, Tokyo (JP)

(21) Appl. No.: 19/336,062

(22) Filed: Sep. 22, 2025

(30) Foreign Application Priority Data
Sep. 27, 2024 (JP) 2024-169516

(51) Int. Cl. G06T 11/00

(52) U.S. Cl. CPC G06T 12/10; G06T 12/20; G06T 2210/41; G06T 2211/448

(57) ABSTRACT

A processor is provided, and the processor specifies a high-attenuation substance region in a projection image acquired by imaging a subject including a high-attenuation substance using a CT apparatus, and derives a corrected projection image by performing correction on the high-attenuation substance region in the projection image to suppress a difference in image quality between the high-attenuation substance region and other regions outside the high-attenuation substance region.

### CROSS REFERENCE TO RELATED APPLICATIONS

The present application claims priority from Japanese Patent Application No. 2024-169516, filed on Sep. 27, 2024, the entire disclosure of which is incorporated herein by reference.

### BACKGROUND

### Technical Field

The present disclosure relates to an image processing apparatus, method, and program.

### Related Art

In a computed tomography (CT) apparatus, in a case where an object having a high X-ray attenuation coefficient, such as metal, is included inside a subject, artifacts occur in a reconstructed image. Such artifacts hinder clinical diagnosis. Therefore, various methods have been proposed to remove artifacts. For example, JP1996-019533A (JP-H08-019533A) has proposed a method of acquiring a tomographic image in which artifacts are reduced by estimating a peak in projection data, which is one of features of artifacts, through an interpolation process using data from a channel that is not affected by a high-attenuation substance, such as a metal object, interpolating a signal value at the peak in the projection data based on the estimated projection data, and reconstructing the interpolated projection data.

However, the method described in JP1996-019533A (JP-H08-019533A) is a method of approximating and interpolating the projection data based on measured projection data adjacent to the peak in the projection data. Therefore, a position of the peak in the projection data is different from a position of the data for interpolating data at the position of the peak. As a result, the data at the position of the peak does not match the measured projection data around the peak, and in the reconstructed tomographic image, a difference in image quality, such as a density or frequency characteristics, occurs between a high-attenuation substance region, such as metal, and a region adjacent to the high-attenuation substance region.

### SUMMARY OF THE INVENTION

The present disclosure has been made in view of the above-described circumstances, and an object of the present disclosure is to reduce a difference in image quality between a high-attenuation substance region and an adjacent region in a tomographic image.

According to the present disclosure, there is provided an image processing apparatus comprising: a processor,
in which the processor is configured to:
   specify a high-attenuation substance region in a projection image acquired by imaging a subject including a high-attenuation substance using a CT apparatus; and
   derive a corrected projection image by performing correction on the high-attenuation substance region in the projection image to suppress a difference in image quality between the high-attenuation substance region and other regions outside the high-attenuation substance region.

In the image processing apparatus according to the present disclosure, the processor may be configured to derive the corrected projection image by performing correction on the high-attenuation substance region in the projection image based on at least one of beam hardening of radiation transmitted through the subject, scattered radiation of radiation transmitted through the subject, or a frequency component of a tomographic image reconstructed from the projection image.

In the image processing apparatus according to the present disclosure, the processor may be configured to:
reconstruct the projection image to derive a provisional tomographic image, specify a provisional high-attenuation substance region in the provisional tomographic image, and specify the high-attenuation substance region in the projection image by forward-projecting the provisional high-attenuation substance region; and
derive a removed tomographic image in which an influence of the high-attenuation substance region has been removed from the provisional tomographic image, derive a corrected high-attenuation substance projection image by forward-projecting the provisional high-attenuation substance region while performing correction on the removed tomographic image based on at least one of the beam hardening of the radiation transmitted through the subject, the scattered radiation of the radiation transmitted through the subject, or the frequency component of the tomographic image reconstructed from the projection image, and derive the corrected projection image by replacing the high-attenuation substance region in the projection image with the corrected high-attenuation substance projection image.

In the image processing apparatus according to the present disclosure, the processor may be configured to perform correction based on the frequency component of the tomographic image, based on at least one of a channel frequency of a detector during back projection of the projection image for reconstruction of the tomographic image, a back projection algorithm, a reconstruction filter, a pixel size of the tomographic image, or a forward projection algorithm used for the forward projection.

In the image processing apparatus according to the present disclosure, the processor may be configured to derive a corrected tomographic image by reconstructing the corrected projection image.

According to the present disclosure, there is provided an image processing method comprising:
causing a computer to:
   specify a high-attenuation substance region in a projection image acquired by imaging a subject including a high-attenuation substance using a CT apparatus; and
   derive a corrected projection image by performing correction on the high-attenuation substance region in the projection image to suppress a difference in image quality between the high-attenuation substance region and other regions outside the high-attenuation substance region.

According to the present disclosure, there is provided an image processing program for causing a computer to execute:
a procedure of specifying a high-attenuation substance region in a projection image acquired by imaging a subject including a high-attenuation substance using a CT apparatus; and
a procedure of deriving a corrected projection image by performing correction on the high-attenuation substance region in the projection image to suppress a difference in image quality between the high-attenuation substance region and other regions outside the high-attenuation substance region.

The technology of the present disclosure may be applied to a program product.

According to the present disclosure, a difference in image quality between a high-attenuation substance region and an adjacent region in a tomographic image can be reduced.

### BRIEF DESCRIPTION OF THE DRAWINGS

FIG. 1 is a schematic configuration diagram of an image processing apparatus according to an embodiment of the present disclosure.

FIG. 2 is a diagram showing a hardware configuration of the image processing apparatus according to the present embodiment.

FIG. 3 is a functional configuration diagram of the image processing apparatus according to the present embodiment.

FIG. 4 is a diagram showing raw data acquired by imaging a head of a subject including metal using a CT apparatus.

FIG. 5 is a diagram showing a flow of processing performed by a specification unit, a correction unit, and a reconstruction unit in the present embodiment.

FIG. 6 is a diagram illustrating specification of a metal region.

FIG. 7 is a diagram illustrating forward projection of the metal region.

FIG. 8 is a diagram illustrating correction of the metal region.

FIG. 9 is a flowchart showing processing performed in the present embodiment.

### DETAILED DESCRIPTION

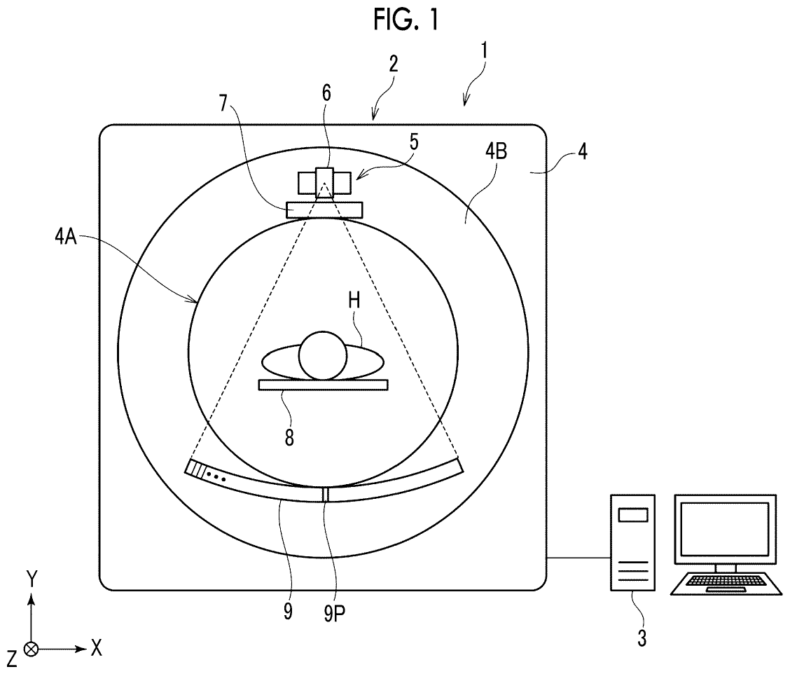

An embodiment of the present disclosure will be described in detail below with reference to the accompanying drawings. First, an example of a configuration of a medical image capturing system comprising an image processing apparatus according to the embodiment of the present disclosure will be described. FIG. 1 is a schematic configuration diagram of the medical image capturing system comprising the image processing apparatus according to the present embodiment.

A medical image capturing system 1 of the present embodiment comprises a CT apparatus 2 and a console 3, as shown in FIG. 1. The CT apparatus 2 comprises a gantry 4 and a patient table 8. In the following description, a horizontal direction in FIG. 1 is referred to as an X-axis, a vertical direction is referred to as a Y-axis, and a direction orthogonal to an XY plane is referred to as a Z-axis. The CT apparatus 2 is an example of a radiographic imaging apparatus.

The gantry 4 has an opening portion 4A, and a subject H to be imaged is disposed within the opening portion 4A while being placed on the patient table 8. The gantry 4 and the patient table 8 are configured to move relative to each other in a Z-axis direction.

Inside the gantry 4, a radiation source 5 including a radiation tube 6 and a bowtie filter 7, and a detector 9 are disposed to face each other with the subject H interposed therebetween. The bowtie filter 7 optimizes an exposure dose by increasing the dose near a center and reducing the dose in the peripheral areas, in order to suppress the exposure dose in peripheral portions. Radiation emitted from the radiation tube 6 is shaped by the bowtie filter 7 into a beam shape suitable for a size of the subject H and is then emitted to the subject H.

The detector 9 detects radiation that has been transmitted through the subject H, and generates projection data corresponding to the dose of the detected radiation. In the detector 9, a plurality of detection elements 9P are disposed in an arc shape centered on a focal point of the radiation tube 6. A direction of an arc shape in which the plurality of detection elements 9P are arranged is referred to as a channel direction.

It should be noted that, in the present embodiment, X-rays are used as an example of the radiation, but the present disclosure is not limited to this, and y-rays or the like can also be used.

The radiation source 5 and the detector 9 are attached to a rotating plate 4B provided in the gantry 4 and are rotated around the subject H by a rotation drive unit (not shown). As the radiation irradiation from the radiation source 5 and the detection of the radiation by the detector 9 are repeatedly performed in conjunction with the rotation of the radiation source 5 and the detector 9, raw data is acquired in a plurality of view units having different projection angles of the radiation onto the subject H, and the projection data is generated from the raw data. The generated projection data is output to the console 3. The projection data is derived by arranging the raw data such that the horizontal axis is the channels of the detector 9 and the vertical axis is the rotation angle of the CT apparatus 2.

The dose of radiation emitted from the radiation tube 6, a rotation speed of the gantry 4, a relative movement speed between the gantry 4 and the patient table 8, and the like are set by the console 3 based on imaging conditions input by an operator, such as a technologist.

The console 3 of the present embodiment performs control related to imaging of the subject H, generation of projection data from raw data acquired by imaging, reconstruction of a tomographic image from the projection data, settings of storage of projection data and image data of the tomographic image, and the like. The console 3 is an example of the image processing apparatus of the present disclosure.

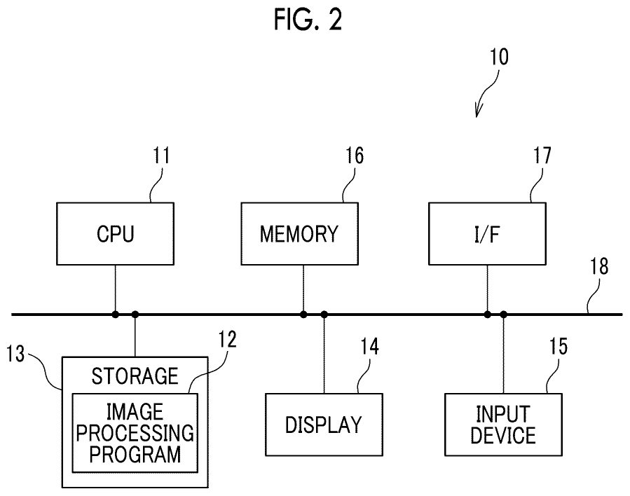

Next, the image processing apparatus according to the present embodiment will be described. First, a hardware configuration of the image processing apparatus according to the present embodiment, which is incorporated into the console 3, will be described with reference to FIG. 2. As shown in FIG. 2, an image processing apparatus 10, which is incorporated into the console 3, is a computer, such as a workstation, a server computer, or a personal computer, and comprises a central processing unit (CPU) 11, a non-volatile storage 13, and a memory 16 as a temporary storage area.

In addition, the image processing apparatus 10 comprises a display 14, an input device 15, and an interface (I/F) 17. The CPU 11, the storage 13, the display 14, the input device 15, the memory 16, and the I/F 17 are connected to a bus 18. The CPU 11 is an example of a processor in the present disclosure.

The storage 13 is implemented using a hard disk drive (HDD), a solid-state drive (SSD), a flash memory, or the like. The storage 13 as a storage medium stores an image processing program 12 installed in the image processing apparatus 10. The CPU 11 reads the image processing program 12 from the storage 13, loads the read image processing program 12 into the memory 16, and executes the loaded image processing program 12.

The display 14 is a device that displays various screens, and is, for example, a liquid crystal display or an electro luminescence (EL) display.

The input device 15 is used by the operator to input imaging conditions for imaging the subject H, instructions related to generation, display, and the like of images, various kinds of information, and the like. Examples of the input device 15 include various switches, buttons, a touch panel, a touch pen, a keyboard, a mouse, and the like. The display 14 and the input device 15 may be integrated into a touch panel display.

The I/F 17 performs communication of various kinds of information with the rotation drive unit (not shown) of the gantry 4, the radiation source 5, and the detector 9 via wired communication or wireless communication.

The image processing program 12 is stored in a storage device of a server computer connected to a network or in a network storage in a state accessible from the outside and is downloaded to and installed in a computer that constitutes the image processing apparatus 10 in response to a request. Alternatively, the image processing program 12 is distributed by being recorded on a recording medium such as a digital versatile disc (DVD) or a compact disc read-only memory (CD-ROM) and is then installed from the recording medium into the computer that constitutes the image processing apparatus 10.

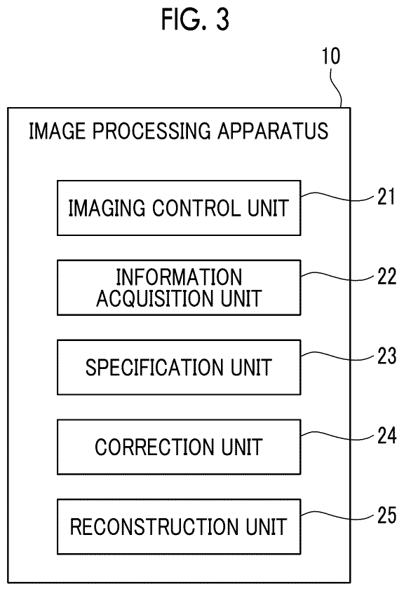

Next, a functional configuration of the image processing apparatus according to the present embodiment will be described. FIG. 3 is a diagram showing the functional configuration of the image processing apparatus according to the present embodiment. As shown in FIG. 3, the image processing apparatus 10 comprises an imaging control unit 21, an information acquisition unit 22, a specification unit 23, a correction unit 24, and a reconstruction unit 25. The CPU 11 executes the image processing program 12 to function as the imaging control unit 21, the information acquisition unit 22, the specification unit 23, the correction unit 24, and the reconstruction unit 25.

The imaging control unit 21 controls each unit of the CT apparatus 2 to perform imaging of the subject H in response to an instruction through the input device 15. In the present embodiment, it is assumed that the head of the subject H is imaged. Additionally, it is assumed for the purpose of description that the head includes metal. The metal is an example of a high-attenuation substance of the present disclosure.

The information acquisition unit 22 acquires the projection data acquired by imaging the subject H from the CT apparatus 2. The image represented by the projection data is a projection image.

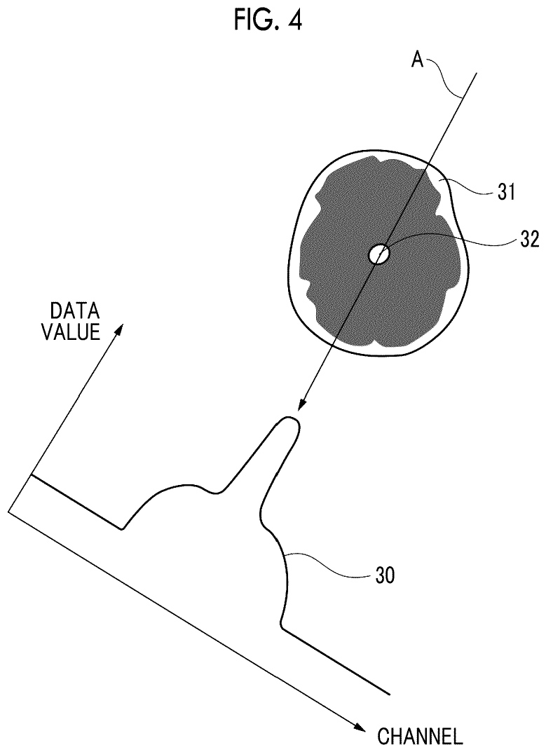

FIG. 4 is a diagram showing the raw data acquired by imaging the head of the subject H including metal using the CT apparatus 2. In FIG. 4, raw data 30 in a case where a head 31 is irradiated with radiation in a direction of an arrow A is shown. In the raw data 30 shown in FIG. 4, a horizontal axis represents a channel direction of the detector 9, and a vertical axis represents a data value. In the raw data 30, the data value is small in a channel (that is, the detection element 9P) that has detected radiation which is not transmitted through the head 31, the data value is large in a channel that has detected radiation which is transmitted through the head 31, and the data value in a channel that has detected radiation which is transmitted through the metal 32 located inside the head 31 exhibits a peak. The projection data is obtained by arranging such raw data with the horizontal axis representing the channel direction of the detector 9 and the vertical axis representing the rotation angle.

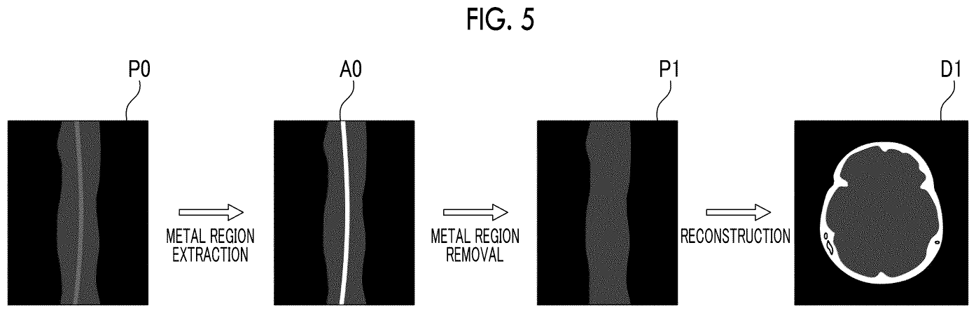

FIG. 5 is a diagram showing a flow of processing performed by the specification unit 23, the correction unit 24, and the reconstruction unit 25 in the present embodiment. As shown in FIG. 5, first, a metal region A0 is extracted from a projection image P0 represented by the projection data. Next, the metal region A0 in the projection image P0 is corrected, and a corrected projection image P1 is derived. Further, the corrected projection image P1 is reconstructed, and a corrected tomographic image D1 is derived. Hereinafter, individual processes performed by the specification unit 23, the correction unit 24, and the reconstruction unit 25 will be described.

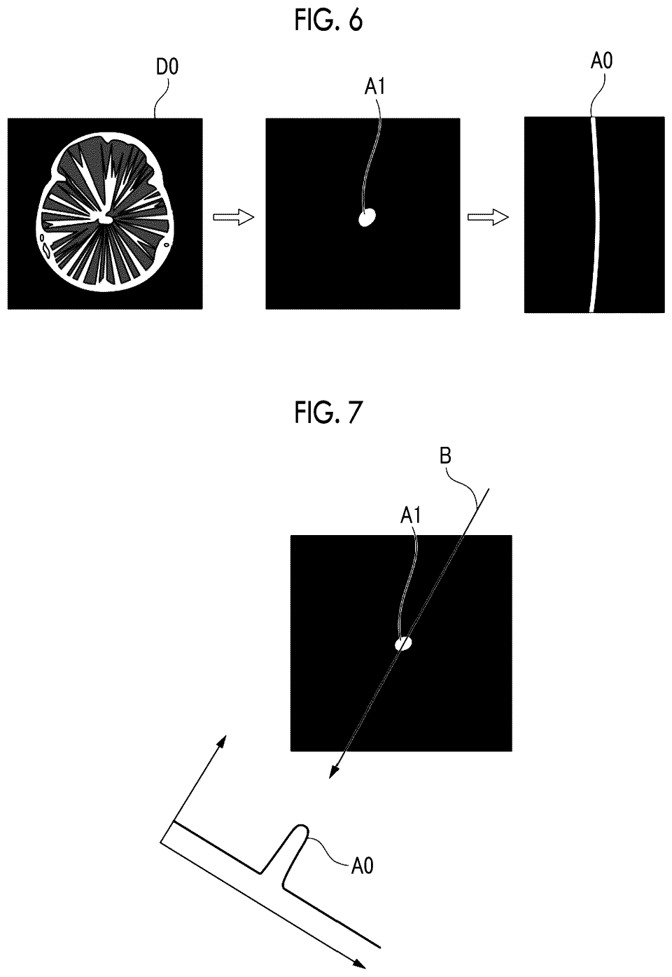

The specification unit 23 specifies the metal region in the projection image. FIG. 6 is a diagram illustrating the specification of the metal region. The specification unit 23 first derives a provisional tomographic image D0 through reconstruction of the projection image P0 by the reconstruction unit 25. Here, the provisional tomographic image D0 includes the metal region and artifacts caused by an influence of the metal. The specification unit 23 removes the artifacts from the provisional tomographic image D0. For example, the specification unit 23 removes the artifacts from the provisional tomographic image D0 by using a removal model constructed to remove artifacts from the tomographic image.

The specification unit 23 specifies a metal region A1 in the provisional tomographic image from which the artifacts have been removed (hereinafter referred to as a removed tomographic image D2). Since the metal region A1 is a high-brightness region in the removed tomographic image D2, the specification unit 23 extracts the metal region A1 by using an extraction model constructed to extract such a high-brightness region. Then, as shown in FIG. 7, the specification unit 23 specifies the metal region A0 in the projection image P0 by forward-projecting the metal region A1 in a direction of an arrow B.

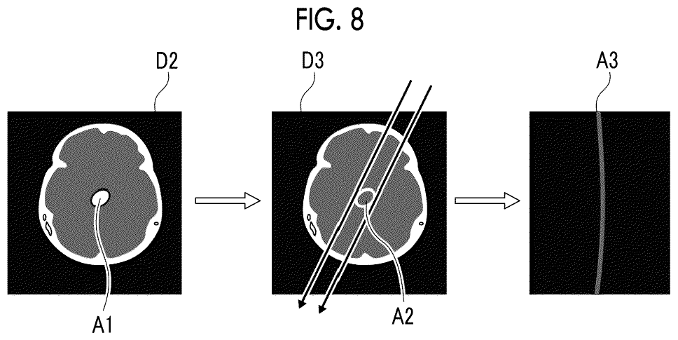

The correction unit 24 derives the corrected projection image P1 by performing correction on the metal region in the projection image P0. FIG. 8 is a diagram illustrating the correction of the metal region. The correction unit 24 derives a provisional corrected tomographic image (referred to as D3) in which the metal region is corrected, by correcting the metal region A1 in the removed tomographic image D2 from which the artifacts have been removed. The correction of the metal region A1 is performed using a correction model that has been trained to interpolate a pixel value of the metal region A1 with a pixel value of a region adjacent to the metal region A1 or to estimate the pixel value of the metal region A1, for example, as described in JP1996-019533A (JP-H08-019533A). Then, a corrected metal region projection image A3 is derived by forward-projecting only a region A2 corresponding to the metal region in the provisional corrected tomographic image D3. In FIG. 8, the forward projection of the region A2 onto the provisional corrected tomographic image D3 is indicated by arrows. Instead of forward-projecting only the region A2, a provisional projection image may be derived by forward-projecting the entire provisional corrected tomographic image D3, and the corrected metal region projection image A3 may be derived by extracting a region corresponding to the metal region from the provisional projection image.

The correction unit 24 corrects the metal region A0 by replacing the metal region A0 in the projection image P0 with the corrected metal region projection image A3 to derive the corrected projection image P1 (refer to FIG. 5).

In this case, the correction unit 24 performs correction to suppress a difference in image quality between the metal region and other regions outside the metal region. Here, the projection image P0 includes the influence of beam hardening on the radiation quality and the influence of scattered radiation caused by the subject H. The influence of the beam hardening on the radiation quality and the influence of the scattered radiation differ between the metal region and other regions outside the metal region in the subject H. Therefore, in a case where the corrected metal region projection image A3 is derived by simply performing forward projection through integration of the provisional corrected tomographic image D3, the influences of the radiation quality and the scattered radiation differ between the corrected metal region projection image A3 and the region adjacent to the metal region A0 in the projection image P0. As a result, the image quality differs between the corrected metal region projection image A3 and the region adjacent to the metal region A0 in the projection image P0.

Therefore, the correction unit 24 derives the corrected metal region projection image A3 in consideration of the influence of the radiation quality and the influence of the scattered radiation. This process is referred to as a first process.

In the present embodiment, regarding the radiation quality, the influence of the beam hardening on the radiation quality is derived in advance by simulating a radiation transmission process in which the radiation is emitted from the radiation tube 6, is transmitted through the subject H, and reaches the detector 9. For example, the transmission process of the radiation in the subject H is derived in advance using the energy spectrum of the radiation at the time of irradiation and the absorption spectrum of the subject H for each energy. In this case, since the tissue of the subject H is complex, the subject H is assumed to consist of three substances: water, bone, and air. The composition of the subject H along the radiation transmission path is derived using the pixel values of the provisional corrected tomographic image D3, as the radiation transmission process. Then, the correction unit 24 derives the corrected metal region projection image A3 by correcting the influence of the radiation quality in the region A2 corresponding to the metal region in a case of forward-projecting the provisional corrected tomographic image D3, based on the previously derived radiation transmission process.

Regarding the scattered radiation, a component that is deviated from the radiation transmission path due to transmission through the subject H, in a process in which the radiation is transmitted in a straight line through a path connecting the radiation tube 6 and the detector 9, is regarded as a scattered radiation component and is derived in advance, for example, using the provisional corrected tomographic image D3. Then, the correction unit 24 derives the corrected metal region projection image A3 by correcting the influence of the scattered radiation in the region A2 corresponding to the metal region in a case of forward-projecting the provisional corrected tomographic image D3, based on the previously derived scattered radiation component.

The correction unit 24 may correct any one of the radiation quality or the scattered radiation or may correct both the radiation quality and the scattered radiation, as the first process. In a case of correcting both the radiation quality and the scattered radiation, by deriving the influences of the radiation quality and the scattered radiation in advance at the same time, it is possible to prevent the occurrence of an error caused by separately correcting only the influence of the radiation quality and only the influence of the scattered radiation.

In addition, the correction unit 24 may be configured to perform correction to suppress the difference in image quality between the metal region and the regions outside the metal region, based on a frequency component of a tomographic image to be derived. This process is referred to as a second process. The frequency component of the tomographic image to be derived varies, for example, depending on a channel frequency of the detector during back projection, a back projection algorithm, a reconstruction filter, a pixel size of the tomographic image, a forward projection algorithm, and the like.

Regarding the channel frequency of the detector, the tomographic image is reconstructed by back-projecting a projection image of a path connecting the radiation tube 6 and each channel (that is, each detection element 9P) of the detector 9 in the projection image. Therefore, the wider the width of the detector 9 is, that is, the lower the channel frequency is, the greater the blurring of the projection image in the channel direction of the detector 9 becomes, and the high-frequency component of the reconstructed tomographic image is lost.

Regarding the back projection algorithm, both the pixels of the tomographic image and the channels of the detector 9 are discrete information having a certain width. Therefore, in a case of back-projecting the projection image with respect to a path passing between the pixels of the tomographic image or between the channels of the detector 9, an interpolation process is required to interpolate an image between the pixels of the tomographic image or between the channels of the detector 9. In this case, the degree of reduction in the high-frequency component of the reconstructed tomographic image varies depending on the type of the interpolation process.

In a case where the specification unit 23 specifies the metal region, the provisional tomographic image D0 is derived by reconstructing the projection image P0. The back projection algorithm is an algorithm that reconstructs the projection image P0.

Regarding the reconstruction filter, the well-known filtered back projection (FBP) uses a filter having a differential characteristic of emphasizing the high-frequency component (such as a ramp filter) in a case of back-projecting the projection image. Although a reconstruction filter that enables a correct reconstructed image to be acquired is theoretically defined, a plurality of reconstruction filters may be prepared depending on the purpose, such as suppressing noise in the projection image or emphasizing structural information of frequency components desired by the user, in order to obtain a tomographic image having the desired frequency. Therefore, the degree of the high-frequency component in the reconstructed tomographic image varies depending on the reconstruction filter used.

Regarding the pixel size of the tomographic image, similarly to the channel frequency of the detector 9, the smaller the pixel size of the tomographic image is (that is, the higher the sampling frequency is), the smaller the deviation between the projection image of the path connecting the radiation tube 6 and the channel of the detector 9 and the pixel position becomes, making it less likely for the high-frequency component of the tomographic image to be lost. On the other hand, the larger the pixel size is (that is, the lower the sampling frequency is), the high-frequency component of the tomographic image is reduced, and fine structures are averaged. Therefore, the degree of the high-frequency component in the tomographic image varies depending on the pixel size of the tomographic image.

Regarding the forward projection algorithm, both the pixels of the projection image and the channels of the detector 9 are discrete information having a certain width. Therefore, in a case of forward-projecting the tomographic image with respect to a path passing between the pixels of the tomographic image or between the channels of the detector 9, an interpolation process is required to interpolate an image between the pixels of the projection image or between the channels of the detector 9. In this case, the frequency components lost by the forward projection vary depending on the type of interpolation process.

Based on the above, in a case of forward-projecting the tomographic image, the frequency components lost by the forward projection can be derived from the frequency components of the tomographic image and a process of interpolating pixels generated by computation performed during the forward projection. In the present embodiment, the frequency components lost by the forward projection are derived in advance.

The correction unit 24, in deriving the corrected metal region projection image A3 by forward-projecting the provisional corrected tomographic image D3 of a path connecting the radiation tube 6 and the detector 9 and including the region A2 corresponding to the metal in the provisional corrected tomographic image D3, emphasizes, in advance, the frequency components of the provisional corrected tomographic image D3 of the path connecting the radiation tube 6 and the detector 9 and including the region A2 corresponding to the metal in the provisional corrected tomographic image D3, based on at least one of the channel frequency of the detector during back projection, the back projection algorithm, the reconstruction filter, the pixel size of the tomographic image, the forward projection algorithm, or the like in order to match the frequency components of a region adjacent to the metal region A0 in the projection image P0 with the frequency components of the corrected metal region projection image A3. As a result, in a case where the corrected metal region projection image A3 is derived by forward-projecting the provisional corrected tomographic image D3 of the path connecting the radiation tube 6 and the detector 9 and including the region A2, it is possible to match the frequency components of the corrected metal region projection image A3 with the frequency components of the region adjacent to the metal region A0 in the projection image P0.

In addition, the correction unit 24 may be configured to derive the corrected metal region projection image A3 by correcting the influence of the radiation quality and the influence of scattered radiation caused by structures other than metal included in the projection image P0. This process is referred to as a third process. In the removed tomographic image D2 mentioned above, artifacts caused by metal are removed, whereas the influences of the radiation quality and the scattered radiation caused by the high-attenuation substance other than metal are not targeted for removal. Therefore, the influences of the radiation quality and the scattered radiation caused by the high-attenuation substance other than metal may not be fully removed, and the influences may remain in the provisional corrected tomographic image D3. For example, between two bones, the influences of the radiation quality and the scattered radiation caused by the bones may not be fully removed and may remain. In this case, as mentioned above, in a case of forward-projecting the provisional corrected tomographic image D3, the influences of the radiation quality and the scattered radiation are further corrected using the provisional corrected tomographic image D3 in which the influences of the radiation quality and the scattered radiation caused by the high-attenuation substance other than metal remain. Therefore, the influences of the radiation quality and the scattered radiation cannot be correctly corrected in a case where the corrected metal region projection image A3 is derived.

Therefore, it is preferable that the correction unit 24 derives the corrected metal region projection image A3 by removing the influences of the radiation quality and the scattered radiation caused by the high-attenuation substance other than metal and then correcting the influences of the radiation quality and the scattered radiation as mentioned above, in a case of forward-projecting the provisional corrected tomographic image D3.

Additionally, the correction unit 24 may be configured to, in correcting the influences of the radiation quality and the scattered radiation as mentioned above and deriving the corrected metal region projection image A3, correct the scattered radiation component that enters the metal region A0 from the region adjacent to the metal region A0 in the projection image P0. This process is referred to as a fourth process. In the fourth process, in the same manner as described above, a component that is deviated from the radiation transmission path due to transmission through the subject H, in a process in which the radiation is transmitted in a straight line through the path connecting the radiation tube 6 and the detector 9, is regarded as the scattered radiation component and is derived in advance. The correction unit 24 need only be configured to acquire the corrected metal region projection image A3 by correcting the influence of the scattered radiation in the region A2 corresponding to the metal based on the scattered radiation component that enters the metal region A0 from the region adjacent to the metal region A0 in a case of forward-projecting the provisional corrected tomographic image D3. By taking into consideration the influence of the radiation quality of the radiation in a case where the influence of the scattered radiation is corrected, the influence of the scattered radiation can be corrected with higher accuracy.

In addition, the correction unit 24 may be configured to, in correcting the influences of the radiation quality and the scattered radiation as mentioned above and deriving the corrected metal region projection image A3, correct the scattered radiation component that enters the region adjacent to the metal region A0 from the metal region A0 in the projection image P0. This process is referred to as a fifth process. In the fifth process, in the same manner as described above, a component that is deviated from the radiation transmission path due to transmission through the subject H, in a process in which the radiation is transmitted in a straight line through the path connecting the radiation tube 6 and the detector 9, is regarded as the scattered radiation component and is derived in advance. Then, the correction unit 24 need only derive the corrected metal region projection image A3 and, further, the corrected projection image P1 by correcting the influence of the scattered radiation that enters the region adjacent to the metal region A0 from the metal region A0 in a case of forward-projecting the provisional corrected tomographic image D3, based on the scattered radiation component that enters the region adjacent to the metal region A0 from the metal region A0. By taking into consideration the influence of the radiation quality of the radiation in a case where the influence of the scattered radiation is corrected, the influence of the scattered radiation can be corrected with higher accuracy.

The correction unit 24 may perform all of the first process to the fifth process described above or may perform one or a plurality of processes of the first process to the fifth process.

The reconstruction unit 25 derives the corrected tomographic image D1 by reconstructing the corrected projection images P1 at the plurality of projection angles.

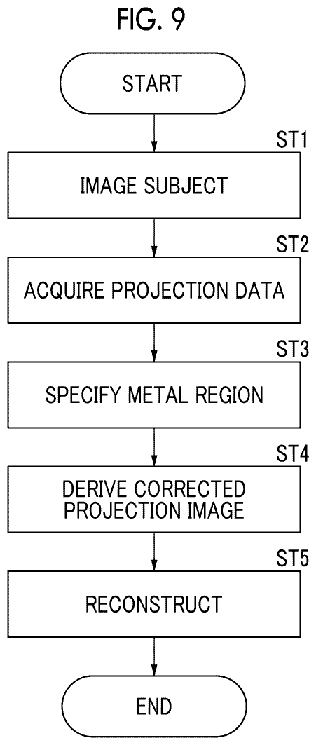

Next, processing performed in the present embodiment will be described. FIG. 9 is a flowchart showing processing performed in the present embodiment. First, the imaging control unit 21 images the subject H using the CT apparatus 2 in response to an instruction from the operator (step ST1), and the information acquisition unit 22 acquires the projection data (step ST2). The specification unit 23 specifies the metal region A0 in the projection image P0 represented by the projection data (step ST3). The correction unit 24 corrects the metal region A0 in the projection image P0 to derive the corrected projection image P1 (step ST4). The reconstruction unit 25 derives the corrected tomographic image D1 by reconstructing the corrected projection image P1 (step ST5), and the processing ends.

As described above, in the present embodiment, the corrected projection image P1 is derived by performing correction to suppress the difference in image quality between the metal region and other regions outside the metal region in the projection image. Therefore, it is possible to reduce the difference in image quality between the metal region and the region adjacent to the metal region in the corrected tomographic image D1 derived by reconstructing the corrected projection image P1.

In the present embodiment, each process is executed by any computer. Additionally, any computer may execute these processes by means of a processor as hardware, a program as software, or a combination thereof. In that case, the processor is configured to execute various types of processing in the present embodiment in cooperation with the program and can function as each unit or each means in the present embodiment. In addition, the execution order of the process by the processor is not limited to the order described above and may be changed as appropriate. Any computer may be a general-purpose computer, a computer for a specific application, a workstation, or another system capable of executing each process.

The processor may be configured using one or more pieces of hardware, and the type of hardware is not limited. For example, the processor may be configured using hardware, such as a central processing unit (CPU), a micro processing unit (MPU), a programmable logic device, such as a field programmable gate array (FPGA), a dedicated circuit that is used to execute specific processing, such as an application-specific integrated circuit (ASIC), a graphic processing unit (GPU), or a neural processing unit (NPU). In addition, the type of hardware may be a combination of different types of hardware. In a case where a plurality of pieces of hardware are configured to execute one or more processes of a certain processor, the plurality of pieces of hardware may be present in devices physically separated from each other or may be present in the same device. Additionally, in any of the embodiments, the order of each process by the processor is not limited to the order described above and may be changed as appropriate. The hardware is configured using an electrical circuit (circuitry) in which circuit elements, such as semiconductor elements, are combined, or the like.

Further, the program may be software, such as firmware or a microcode. In addition, the program may be, for example, a program module group, and each function thereof may be implemented by a processor configured to execute the corresponding function. The program may be a program code or a plurality of code segments stored in one or more non-transitory computer-readable media (for example, storage media, other storages, or the like). The program may be distributed and stored across a plurality of non-transitory computer-readable media that are present in devices physically separated from each other. The program code or the code segments may represent any combination of procedures, functions, subprograms, routines, subroutines, modules, software packages, classes, or commands, data structures, or program statements. The program code or the code segment may be connected to another code segment or a hardware circuit by transmitting and receiving information, data, an argument, a parameter, or contents of a memory.

Additionally, in the above-described embodiment, an aspect has been described in which the image processing program 12 is stored (installed) in advance in the storage 13, but the present disclosure is not limited to this aspect. The image processing program 12 may be provided in a form recorded on a recording medium, such as a compact disc read-only memory (CD-ROM), a digital versatile disc read-only memory (DVD-ROM), and a universal serial bus (USB) memory. Further, the image processing program 12 may be downloaded from an external device via the network.

The technology of the present disclosure extends to all kinds of program products. The program product includes all forms of products for providing a program. For example, the program product includes a program provided through a network such as the Internet, a non-transitory computer-readable recording medium, such as a CD-ROM, a DVD, and a USB memory in which the program is stored, and the like.

Hereinafter, the supplementary claims of the present disclosure will be described.

### (Supplementary Claim 1)

An image processing apparatus comprising:
a processor,
in which the processor is configured to:
   specify a high-attenuation substance region in a projection image acquired by imaging a subject including a high-attenuation substance using a CT apparatus; and
   derive a corrected projection image by performing correction on the high-attenuation substance region in the projection image to suppress a difference in image quality between the high-attenuation substance region and other regions outside the high-attenuation substance region.

### (Supplementary Claim 2)

The image processing apparatus according to Supplementary Claim 1,
in which the processor is configured to derive the corrected projection image by performing correction on the high-attenuation substance region in the projection image based on at least one of beam hardening of radiation transmitted through the subject, scattered radiation of radiation transmitted through the subject, or a frequency component of a tomographic image reconstructed from the projection image.

### (Supplementary Claim 3)

The image processing apparatus according to Supplementary Claim 2,
in which the processor is configured to:
   reconstruct the projection image to derive a provisional tomographic image, specify a provisional high-attenuation substance region in the provisional tomographic image, and specify the high-attenuation substance region in the projection image by forward-projecting the provisional high-attenuation substance region; and
   derive a removed tomographic image in which an influence of the high-attenuation substance region has been removed from the provisional tomographic image, derive a corrected high-attenuation substance projection image by forward-projecting the provisional high-attenuation substance region while performing correction on the removed tomographic image based on at least one of the beam hardening of the radiation transmitted through the subject, the scattered radiation of the radiation transmitted through the subject, or the frequency component of the tomographic image reconstructed from the projection image, and derive the corrected projection image by replacing the high-attenuation substance region in the projection image with the corrected high-attenuation substance projection image.

### (Supplementary Claim 4)

The image processing apparatus according to Supplementary Claim 3,
in which the processor is configured to perform correction based on the frequency component of the tomographic image, based on at least one of a channel frequency of a detector during back projection of the projection image for reconstruction of the tomographic image, a back projection algorithm, a reconstruction filter, a pixel size of the tomographic image, or a forward projection algorithm used for the forward projection.

### (Supplementary Claim 5)

The image processing apparatus according to any one of Supplementary Claims 1 to 4,
in which the processor is configured to derive a corrected tomographic image by reconstructing the corrected projection image.

### (Supplementary Claim 6)

An image processing method comprising:
causing a computer to:
   specify a high-attenuation substance region in a projection image acquired by imaging a subject including a high-attenuation substance using a CT apparatus; and
   derive a corrected projection image by performing correction on the high-attenuation substance region in the projection image to suppress a difference in image quality between the high-attenuation substance region and other regions outside the high-attenuation substance region.

### (Supplementary Claim 7)

An image processing program for causing a computer to execute:
a procedure of specifying a high-attenuation substance region in a projection image acquired by imaging a subject including a high-attenuation substance using a CT apparatus; and
a procedure of deriving a corrected projection image by performing correction on the high-attenuation substance region in the projection image to suppress a difference in image quality between the high-attenuation substance region and other regions outside the high-attenuation substance region.

What is claimed is:

1. An image processing apparatus comprising:
a processor,
wherein the processor is configured to:
specify a high-attenuation substance region in a projection image acquired by imaging a subject including a high-attenuation substance using a CT apparatus; and
derive a corrected projection image by performing correction on the high-attenuation substance region in the projection image to suppress a difference in image quality between the high-attenuation substance region and other regions outside the high-attenuation substance region.

2. The image processing apparatus according to claim 1,
wherein the processor is configured to derive the corrected projection image by performing correction on the high-attenuation substance region in the projection image based on at least one of beam hardening of radiation transmitted through the subject, scattered radiation of radiation transmitted through the subject, or a frequency component of a tomographic image reconstructed from the projection image.

3. The image processing apparatus according to claim 2,
wherein the processor is configured to:
reconstruct the projection image to derive a provisional tomographic image, specify a provisional high-attenuation substance region in the provisional tomographic image, and specify the high-attenuation substance region in the projection image by forward-projecting the provisional high-attenuation substance region; and
derive a removed tomographic image in which an influence of the high-attenuation substance region has been removed from the provisional tomographic image, derive a corrected high-attenuation substance projection image by forward-projecting the provisional high-attenuation substance region while performing correction on the removed tomographic image based on at least one of the beam hardening of the radiation transmitted through the subject, the scattered radiation of the radiation transmitted through the subject, or the frequency component of the tomographic image reconstructed from the projection image, and derive the corrected projection image by replacing the high-attenuation substance region in the projection image with the corrected high-attenuation substance projection image.

4. The image processing apparatus according to claim 3,
wherein the processor is configured to perform correction based on the frequency component of the tomographic image, based on at least one of a channel frequency of a detector during back projection of the projection image for reconstruction of the tomographic image, a back projection algorithm, a reconstruction filter, a pixel size of the tomographic image, or a forward projection algorithm used for the forward projection.

5. The image processing apparatus according to claim 1,
wherein the processor is configured to derive a corrected tomographic image by reconstructing the corrected projection image.

6. The image processing apparatus according to claim 2,
wherein the processor is configured to derive a corrected tomographic image by reconstructing the corrected projection image.

7. The image processing apparatus according to claim 3,
wherein the processor is configured to derive a corrected tomographic image by reconstructing the corrected projection image.

8. The image processing apparatus according to claim 5,
wherein the processor is configured to derive a corrected tomographic image by reconstructing the corrected projection image.

9. An image processing method comprising:
causing a computer to:
specify a high-attenuation substance region in a projection image acquired by imaging a subject including a high-attenuation substance using a CT apparatus; and
derive a corrected projection image by performing correction on the high-attenuation substance region in the projection image to suppress a difference in image quality between the high-attenuation substance region and other regions outside the high-attenuation substance region.

10. A non-transitory computer-readable storage medium that stores an image processing program for causing a computer to execute:
a procedure of specifying a high-attenuation substance region in a projection image acquired by imaging a subject including a high-attenuation substance using a CT apparatus; and
a procedure of deriving a corrected projection image by performing correction on the high-attenuation substance region in the projection image to suppress a difference in image quality between the high-attenuation substance region and other regions outside the high-attenuation substance region.
